(19) United States
(12) Patent Application Publication
(10) Pub. No.: US 2015/0086058 A1
(43) Pub. Date: Mar. 26, 2015

(54) Microphone having a microphone capsule, dynamic sound transducer for headphones, earphones or headsets and method for producing a microphone capsule or a sound transducer

(71) Applicant: Sennheiser electronic GmbH & Co. KG, Wedemark (DE)

(72) Inventors: Alwin Harms, Wedemark (DE); Heinz Epping, Hildesheim (DE); André Michaelis, Wedemark (DE); Günter Pöppel, Stadthagen (DE)

(21) Appl. No.: 14/389,050

(22) PCT Filed: Mar. 26, 2013
(86) PCT No.: PCT/EP2013/056363

§ 371 Date: Sep. 29, 2014

(30) Foreign Application Priority Data
Mar. 30, 2012 (DE) 10 2012 205 230.5

(51) Int. Cl. H04R 7/16; H04R 1/08

(52) U.S. Cl. CPC H04R 7/16; H04R 1/08
USPC 381/369

(57) ABSTRACT

A microphone having a microphone capsule (10) is provided. The microphone capsule (10) has a diaphragm carrier (40), a diaphragm (20) and an adhesive tape ring (30) which is used to fasten the diaphragm (20) to or in the diaphragm carrier (40). The microphone capsule (10) is in the form of a dynamic sound transducer. A dynamic sound transducer for headphones, earphones or headsets is also provided. The sound transducer has a diaphragm carrier (40), a diaphragm (20) and a moving coil (22) which is coupled to the diaphragm. In a similar manner to the microphone capsule, the sound transducer has an adhesive tape ring (30) between the diaphragm (20) and the diaphragm carrier, which ring is used to fasten the diaphragm (20) to the diaphragm carrier (40).

The present invention concerns a microphone having a microphone capsule and a dynamic sound transducer for headphones, earphones or headsets and a method for producing a microphone capsule or a sound transducer.

A microphone capsule typically has a diaphragm carrier on which a diaphragm is fixed. Typically the diaphragm is fixed to the diaphragm carrier with a wet adhesive. When applying a wet adhesive to the diaphragm carrier or to the diaphragm it is very difficult to reproducibly provide the required amount and the required distribution of the adhesive. When the diaphragm is then placed on the diaphragm carrier or the rind of wet adhesive that can then involve displacement of the adhesive into the corrugation region of the diaphragm. After the wet adhesive has set that can result in irregular stiffening of the diaphragm in the corrugation region. That is detrimental as that causes an increased susceptibility to wobble on the part of the transducer.

The following documents were searched in the German patent application from which priority is claimed: DE 29 805 510 U1, DE 60 2004 002 088 T2, US 2002/0176597 A1; 3M Industrial Business, Converter Markets, Industrial Adhesives and Tapes Division, USA; VHB™ Adhesive Transfer Tapes with Adhesive 100MP F9460 PC F9469 PC F9473PC—company publication.

Therefore an object of the present invention is to provide a microphone having a microphone capsule and a corresponding method for producing the microphone capsule, which ensures uniform stiffening of a corrugation region of the diaphragm even in mass production.

That object is attained by a microphone having a microphone capsule as set forth in claim 9, a method for producing a microphone capsule as set forth in claim 5 and a dynamic sound transducer as set forth in claim 12.

Thus there is provided a microphone having a microphone capsule. The microphone capsule has a diaphragm carrier, a diaphragm and an adhesive tape ring which is used to fix the diaphragm on or in the diaphragm carrier. The microphone capsule is in the form of a dynamic sound transducer.

The use of a ring comprising adhesive tape makes it possible to achieve a higher level of precision in processing the microphone capsule. Such precision in processing is not possible with a fluid adhesive because a fluid adhesive always runs.

According to an aspect of the present invention the adhesive tape ring can be of a double-sided or single-sided adhesive nature. The adhesive tape ring can also have a carrier layer.

According to an aspect of the present invention the diaphragm carrier has an annular diaphragm support on which the adhesive tape ring is placed. An outer portion of the diaphragm is then fixed on the adhesive tape ring.

The increased degree of precision in processing with the microphone according to the invention means that it is possible to produce in particular sound transducers of a smaller diameter, that is to say of a diaphragm diameter of ≦80 mm. The advantage of the increased precision is apparent in particular in relation to transducers with a diaphragm diameter of ≦40 mm.

According to an aspect of the present invention the adhesive ring can be of a width of ≦1 mm in the radial direction. That is possible only due to the increased precision in processing as a ring comprising an adhesive tape instead of a fluid adhesive is used.

According to an aspect of the present invention the adhesive tape ring forms a closed contour. This makes it possible to prevent air from inadvertently passing through transitional locations between a plurality of portions of adhesive tapes. In addition the use of just a single piece (that is to say the adhesive tape ring) in assembly represents a considerable advantage. In that respect only one piece has to be placed instead of positioning a plurality of adhesive pieces relative to each other.

According to an aspect of the present invention the diaphragm is of a round configuration as this permits more uniform distribution of force in the diaphragm and thus a low-distortion transducer.

The invention also concerns a method for producing a microphone capsule having a diaphragm carrier and a diaphragm. An adhesive tape ring is cut out of an adhesive tape by means of laser cutting. The ring is pieced on or in the diaphragm carrier and the diaphragm is placed on the adhesive tape ring.

According to an aspect of the present invention a vacuum stamp is placed on a first side of the adhesive tape and the laser is placed on the second side of the adhesive tape.

According to a further aspect of the present invention an adhesive region of the adhesive tape ring is freed with the laser and the outer region of the adhesive tape ring is cut out with the laser.

The invention also concerns a dynamic sound transducer for headphones, earphones or headsets. The sound transducer has a diaphragm carrier, a diaphragm, a moving coil coupled to the diaphragm and an adhesive tape ring which is provided between the diaphragm and the diaphragm carrier for fixing the diaphragm to the diaphragm carrier. The adhesive tape ring of the dynamic sound transducer can be of a configuration like the adhesive tape ring of the above-described microphone.

The invention concerns the notion of using an adhesive tape film ring (for example a double-sided adhesive tape), instead of a wet adhesive, for fixing the diaphragm on the diaphragm carrier. That is advantageous in particular because that makes it possible to ensure that the adhesive is of a uniform thickness in the form of an adhesive tape film.

According to the invention the required adhesive tape film ring can be cut out of an adhesive tape strip by means of a laser.

The defined adhesive tape film makes it possible to achieve more uniform adhesion of the diaphragm to the diaphragm carrier. Furthermore it is possible to enable the diaphragm to be mounted at the entire diaphragm periphery on the diaphragm carrier in a condition of being free from inherent stress. According to the invention an adhesive tape ring can be produced for example from a double-sided adhesive tape or from a single-sided adhesive tape, in which case the adhesive tape film ring is placed together with a carrier film on the diaphragm carrier. The carrier film can then be removed and the adhesive tape film ring remains on the diaphragm carrier. The diaphragm can then be fitted and pressed in place.

With the microphone capsule according to the invention, the method according to the invention for producing the microphone capsule and the dynamic sound transducer, it is possible to provide a defined adhesive material or adhesive tape surface on the diaphragm support. That also makes it possible to achieve appropriate separation of the fixed region of the diaphragm which remains on the adhesive tape film ring, and the flexible or moving region of the diaphragm. The corrugation of the diaphragm is no longer only partially stiffened (for example due to a creeping wet adhesive). The thickness of the adhesive ring can be precisely determined and selected by the choice of the thickness of the adhesive tapes used for producing the adhesive tape ring. The damping properties of the diaphragm mounting connection can be influenced by the choice of the thickness of the adhesive tape. An increasing thickness of the adhesive tape layer proportionately increases the softness of the diaphragm in the radial direction. That is advantageous because the sound transducer or the microphone capsule is accordingly less susceptible to partial natural oscillations.

According to the invention the microphone is in the form of a dynamic sound transducer.

Further configurations of the invention are subject-matter of the appendant claims.

Advantages and embodiments by way of example of the invention are described in greater detail hereinafter with reference to the drawing.

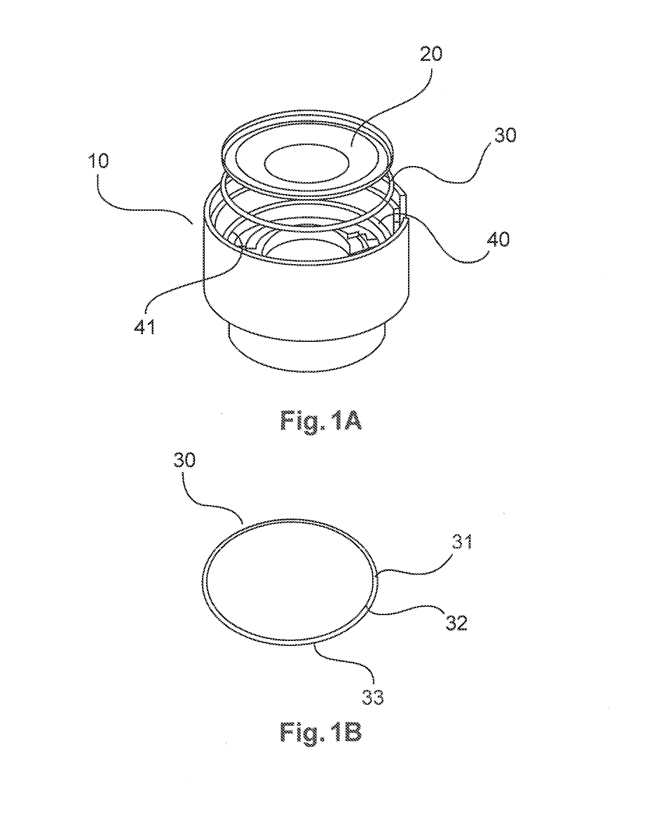

FIGS. 1A and 1B show perspective views of a microphone capsule according to a first embodiment,

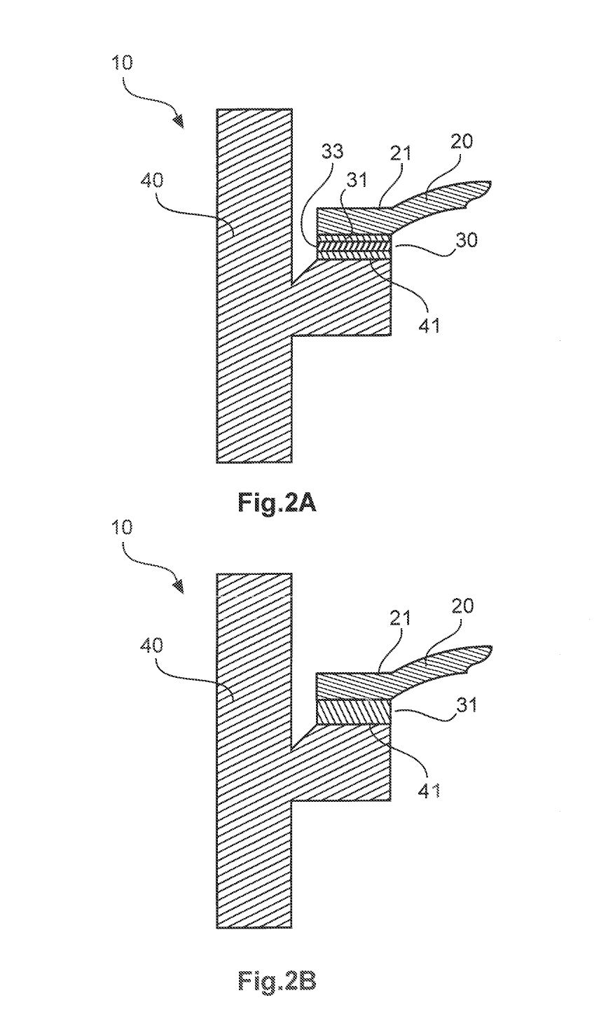

FIGS. 2A and 2B each show a diagrammatic sectional view of a microphone capsule according to a second embodiment,

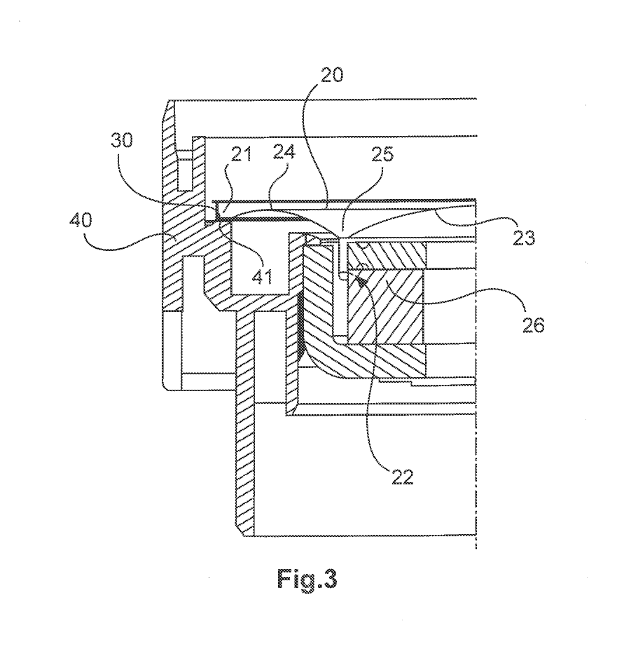

FIG. 3 shows a diagrammatic sectional view of a microphone capsule according to a third embodiment, and

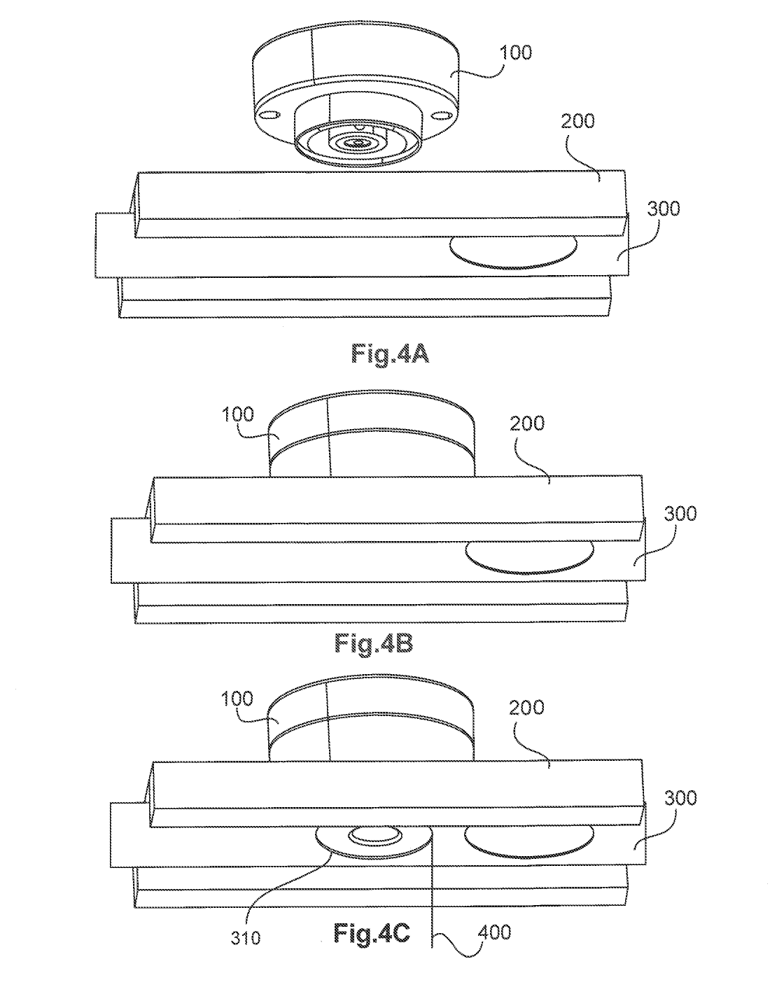

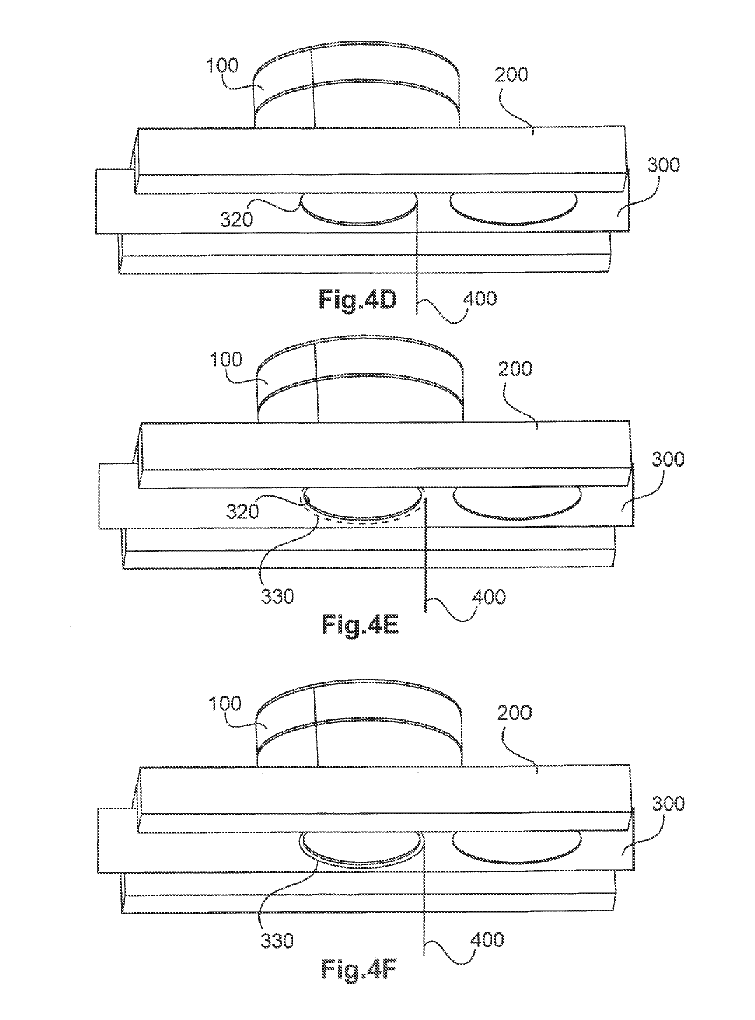

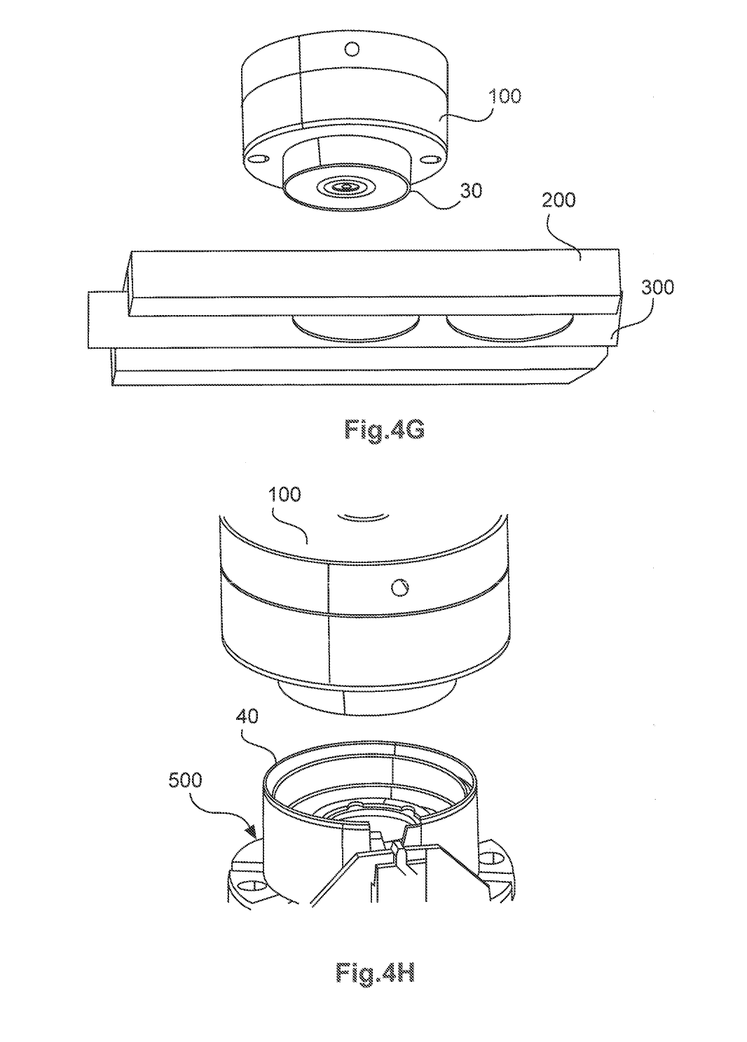

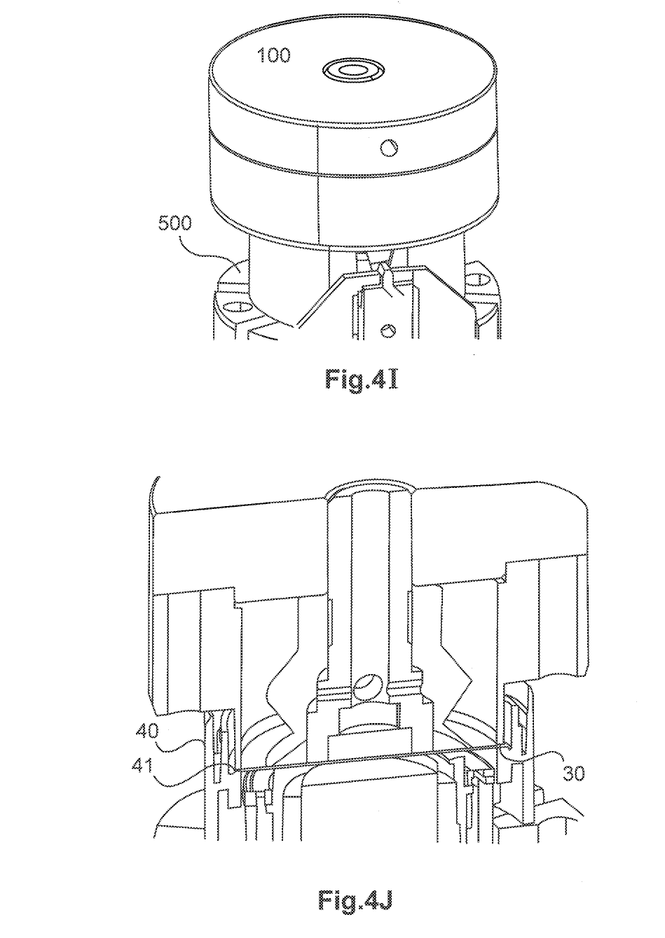

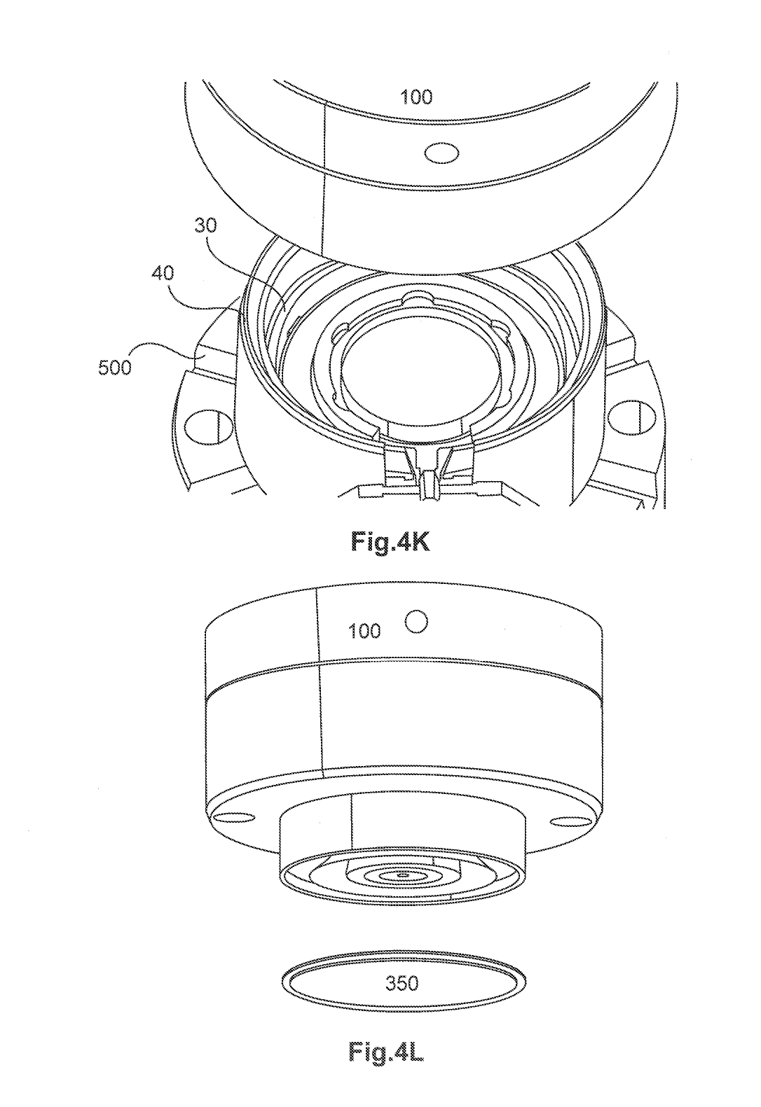

FIGS. 4A through 4L each show a perspective view in a method for producing a microphone capsule according to a fourth embodiment.

FIGS. 1A and 1B show a perspective view of a microphone capsule according to a first embodiment. FIG. 1A shows a perspective view of a microphone capsule according to the first embodiment. The microphone capsule 10 has a diaphragm carrier 40, an adhesive tape (film) ring 30 and a diaphragm 20. The diaphragm 20 is mounted on or in the diaphragm carrier 40 by means of the adhesive tape film ring 30. In particular the adhesive tape film ring 30 is placed on a diaphragm support 41 and the diaphragm 20 is then fitted on to the adhesive tape film ring 30.

FIG. 1B shows the adhesive tape film ring 30. The adhesive tape film ring is produced from an adhesive tape and can have a freed region (adhesive region) 32 and a carrier material 33. The adhesive tape film ring 30 is of a radial width of ≦1 mm. The diaphragm 20 according to the first embodiment is of a diameter of ≦80 mm and in particular ≦40 mm. As shown in FIG. 1B the adhesive tape film ring 30 is of a dosed contour. The outside diameter of the adhesive tape film ring is ≦80 mm and in particular ≦40 mm.

FIGS. 2A and 2B each show a diagrammatic sectional view of a microphone capsule according to a second embodiment. FIGS. 2A and 2B each show a diagrammatic sectional view of a part of a microphone capsule according to a second embodiment. The microphone capsule according to the second embodiment can be based on the microphone capsule of the first embodiment. The microphone capsule has a diaphragm carrier 40 with a diaphragm support 41, an adhesive tape film ring 30 and a diaphragm 20. The adhesive tape film ring 30 is preferably placed on the diaphragm support 41. The diaphragm 20 has for example an outer region 21 which is placed on the adhesive tape film ring 30.

In an embodiment as shown in FIG. 2A the adhesive tape 30 has a carrier layer 33 in the adhesive tape film. In the FIG. 2B embodiment the adhesive tape does not have a carrier layer.

FIG. 3 shows a diagrammatic sectional view of a microphone capsule according to a third embodiment. The microphone capsule of the third embodiment can be based on or derived from a microphone capsule according to the first or second embodiment. The microphone capsule is designed for a dynamic sound transducer. The microphone capsule has a diaphragm carrier 40 having an inwardly disposed diaphragm support 41, a diaphragm 20 and an adhesive tape film ring 30 which is placed on the diaphragm support 41 and serves for fixing the diaphragm 20. In particular an outer region 21 of the diaphragm is fixed or glued to the adhesive tape film ring 30. The diaphragm typically has a corrugation 25 and a central portion 23. A moving coil 22 which co-operates with a solenoid system 26 of the transducer can be provided in the region of the corrugation 25.

According to the invention the adhesive tape film ring 30 is produced from an adhesive tape, that is to say an adhesive which is not fluid and which does not creep. Optionally the adhesive tape can be of a double-sided adhesive nature.

The microphone or the microphone capsule according to the first, second or third embodiment is a microphone capsule which is in the form of a dynamic sound transducer.

FIGS. 4A through 4L each show a perspective view in a method for producing a microphone capsule according to a fourth embodiment. A microphone capsule according to the first, second or third embodiment can be produced with the method for producing a microphone capsule according to the fourth embodiment. FIG. 4A shows a vacuum stamp 100, a guide 200 and an adhesive tape 300.

In FIG. 4B the vacuum stamp is applied to a side of the adhesive tape 300. A laser 400 is activated in FIG. 4C. In FIG. 4D an annular portion 320 of the adhesive tape 300 is freed or exposed. In FIG. 4F a ring 330 is cut out by the laser 400. In that operation the laser 400 cuts through the complete adhesive tape 300. In FIG. 4G the vacuum stamp is removed from the adhesive tape so that the adhesive tape ring 30 remains on the vacuum stamp. In FIG. 4H the vacuum stamp 100 (with the adhesive tape ring 30) moves into a diaphragm holder 40 which is fixed on a holder 500. In FIG. 4I the adhesive tape ring is placed on the diaphragm support. FIG. 4J shows a diagrammatic sectional view through FIG. 4I. In FIG. 4K the vacuum stamp is then removed while the adhesive tape ring 30 remains on the diaphragm support 41. In FIG. 4L the residue of the adhesive tape can then be disposed of.

The microphone capsule produced in accordance with the third embodiment has a diaphragm of a diameter of ≦80 mm and in particular a diameter of ≦40 mm. That means that the outside diameter of the adhesive tape ring 30 is also ≦80 mm and in particular ≦40 mm. The width of the adhesive tape ring 30 is ≦1 mm. The adhesive tape ring 30 is of a closed contour.

According to a fourth embodiment a dynamic sound transducer is provided for headphones, earphones or headsets. The sound transducer has a diaphragm carrier 40, a diaphragm 20, a moving coil 22 and an adhesive tape ring 30. The configuration of the diaphragm carrier 40, the diaphragm 20, the moving coil 22 and the adhesive tape ring 30 according to the fourth embodiment can correspond to the configuration of the diaphragm carrier 40, the diaphragm 20, the moving coil 22 and the adhesive tape ring 30 according to the first, second or third embodiment.

According to a further embodiment of the invention there is provided an electroacoustic dynamic sound transducer having a diaphragm carrier 40, a diaphragm 20, a moving coil 22 coupled to the diaphragm 20, and an adhesive tape ring 30 between the diaphragm 20 and the diaphragm carrier 40 for fixing the diaphragm 20 to the diaphragm carrier 40. That electroacoustic dynamic sound transducer can optionally serve or be used in a microphone or in a sound transducer for earphones or headphones, but not as a sound transducer for loudspeakers.

According to the invention a dynamic sound transducer is a sound transducer which has a diaphragm with a moving coil coupled thereto, the moving coil moving in a magnetic field of a solenoid system.

According to the invention the diameter of the diaphragm is ≦5 cm.

1. A microphone comprising
a microphone capsule (10) which has a diaphragm carrier (40), a diaphragm (20) and an adhesive tape ring (30),
wherein the adhesive tape ring (30) glues or fixes the diaphragm (20) to the diaphragm carrier (40),
wherein the microphone capsule (10) is in the form of a dynamic sound transducer.

2. A microphone as set forth in claim 1 wherein
the adhesive tape ring (30) has a carrier layer.

3. A microphone as set forth in claim 1 or claim 2 wherein
the diaphragm carrier (40) has an annular diaphragm support (41) on which the adhesive tape ring (30) is placed,
wherein the diaphragm (20) has an annular outer portion (21) which is placed on the adhesive tape ring (30).

4. A microphone as set forth in one of claims 1 through 3 wherein
the adhesive tape ring (30) is of a double-sided adhesive nature.

5. A microphone as set forth in one of claims 1 through 4 wherein
a diameter of the diaphragm (20) is ≦80 mm and in particular ≦40 mm.

6. A microphone as set forth in one of claims 1 through 5 wherein
the adhesive tape ring (30) is of a width of ≦1 mm in the radial direction.

7. A microphone as set forth in one of claims 2 through 6 wherein
the adhesive tape ring (30) is of a closed contour.

8. A microphone as set forth in one of claims 1 through 7 wherein
the diaphragm (20) is round.

9. A method for producing a microphone capsule or a dynamic sound transducer having a diaphragm carrier (40) and a diaphragm (20) which is in the form of a dynamic sound transducer, comprising the steps:
laser cutting an adhesive tape ring (30) from an adhesive tape (300),
placing the cut-out adhesive tape ring (30) on or in the diaphragm carrier (40), and
fitting the diaphragm (20) on to the adhesive tape ring (30).

10. A method as set forth in claim 5 and further comprising the steps:
applying a vacuum stamp (100) on a first side of the adhesive tape (300), and
cutting a ring out of the adhesive tape (300) by a laser from the second side of the adhesive tape (300).

11. A method as set forth in claim 9 or claim 10 comprising the steps:
freeing an adhesive portion of the adhesive tape ring (30) by the laser (400), and
cutting out the outer contour of the adhesive tape ring (30) by means of the laser (400).

12. A dynamic sound transducer for headphones, earphones or headsets comprising
a diaphragm carrier (40),
a diaphragm (20),
a moving coil (22) coupled to the diaphragm (20), and
an adhesive tape ring (30) between the diaphragm (20) and the diaphragm carrier (40) for fixing the diaphragm (20) to the diaphragm carrier (40).
